(19) United States
(12) Patent Application Publication
(10) Pub. No.: US 2019/0289085 A1
(43) Pub. Date: Sep. 19, 2019

(54) SYSTEM AND METHOD FOR TRACKING ONLINE USER BEHAVIOR ACROSS BROWSERS OR DEVICES

(71) Applicants: Kyle Miller, Sioux City, IA (US); Christian Ricci, Chicago, IL (US)

(72) Inventors: Kyle Miller, Sioux City, IA (US); Christian Ricci, Chicago, IL (US)

(73) Assignee: Indigenous Software, Inc., San Diego, CA (US)

(21) Appl. No.: 16/351,228

(22) Filed: Mar. 12, 2019

Related U.S. Application Data
(60) Provisional application No. 62/642,335, filed on Mar. 13, 2018.

(51) Int. Cl. H04L 29/08; H04L 12/58; H04W 4/14; G06F 16/23; G06F 16/955

(52) U.S. Cl. CPC H04L 67/22; H04L 67/02; H04L 67/146; G06F 16/9566; H04W 4/14; G06F 16/2379; H04L 51/10

(57) ABSTRACT

A method of tracking online user behavior. The method calls for providing a networked computer server which includes a web hosting platform. The computer server is configured to provide a user access to the web hosting platform. The method further requires creating a unique identifier for the user of the web hosting platform. The unique identifier is associated with a first device employed by the user to access the web hosting platform. The method includes creating a contact record configured to store identifying information of the user and linking the contact record to the unique identifier. Further, the method includes creating an activity record for the user by linking the activity record to the unique identifier. In addition, the method calls for storing the activity record, unique identifier, and contract record in a database to generate a track record of the user's online behavior for display by the computer server.

### CROSS-REFERENCE TO RELATED PATENT APPLICATION

This patent application claims the benefit of U.S. Provisional Patent Application No. 62/642,335, filed Mar. 13, 2018, the entire teachings and disclosure of which are incorporated herein by reference thereto.

### FIELD OF THE INVENTION

This invention generally relates to a system and method for tracking a user's online behavior.

### BACKGROUND OF THE INVENTION

Tracking a user's interaction with internet web assets using conventional means is typically hampered by constraints on cookie visibility (i.e., cookies are visible to services at the same domain where they were set), user and browser-applied controls on “third party” cookies (e.g., preventing cookies from being set except by the domain currently being accessed), cookie blocking, incognito browser modes, and the user's inclination for engaging with same web assets over time, but from multiple devices and browsers.

Traditional cookie-based systems are limited to identification based on a single browser on a single device. Additionally, cookie-based identifiers are vulnerable to client-based obfuscation (clearing cookies, blocking cookies, etc.). There is no inherent way to link cookies across devices and browsers.

Embodiments of the present invention provide an improvement to conventional cookie-based methods for tracking such online user behavior. These and other advantages of the invention, as well as additional inventive features, will be apparent from the description of the invention provided herein.

### BRIEF SUMMARY OF THE INVENTION

In one aspect, embodiments of the invention provide a method of tracking online user behavior. The method calls for providing a networked computer server which includes a web hosting platform. The computer server is configured to provide a user access to the web hosting platform. The method further requires creating a unique identifier for the user of the web hosting platform. The unique identifier is associated with a first device employed by the user to access the web hosting platform. The method includes creating a contact record configured to store identifying information of the user and linking the contact record to the unique identifier. Further, the method includes creating an activity record for the user by linking the activity record to the unique identifier. In addition, the method calls for storing the activity record, unique identifier, and contract record in a database to generate a track record of the user's online behavior for display by the computer server.

In certain embodiments, the method also includes creating a session event record for each session in which the user accesses the web hosting platform, wherein each session event record includes a unique session identifier. Furthermore, each session event record may be linked to the activity record. In other embodiments, the method calls for creating a page event record for each webpage the user visits during a session, wherein each page event record includes a unique page identifier. Also, each page event record may be linked to the session event record for the session in which the page event record was created.

In a further embodiment, the aforementioned analytics include one of the webpages visited, length of time spent on each webpage, the number of internet sessions, the time of occurrence of the internet sessions, and the geographical location(s) of the one or more users. Furthermore, creating the unique identifier for the user may include analyzing a plurality of features, of the first device employed by the user and of a web browser of the user, that are visible to the computer server. In some embodiments, the plurality of features are combined using a hash function to create a fixed-length string that serves as the unique identifier.

The plurality of features may include one or more of a browser identifier, a device language, a screen color depth, screen resolution, maximum available screen resolution, hardware concurrency, device memory information, whether touch input is supported, and time zone information. Additionally, the plurality of features may include one or more of CPU information, operating system information, installed plugins, the amount of local storage allowed, the amount of session storage allowed, whether an ad blocker being used, available features in the web browser, audio support characteristics, and available fonts. Alternatively, the plurality of features may include one or more indicators in which the information reported by the web browser is different from the information provided by the first device employed by the user.

The aforementioned method may also include using a tracking program to track off-platform online behavior of the user when the user accesses websites without using the web-hosting platform. In certain embodiments, using the tracking program to track off-platform online behavior of the user includes using a javascript library to track off-platform online behavior of the user. The tracking program may be added to a webpage such that when the user visits the webpage without using the web-hosting platform, the tracking program transmits information, regarding the online behavior of the user, to the computer server.

In a particular embodiment, the aforementioned tracking program calculates the unique identifier of the user, and transmits data to a URL for the computer server, which encodes and stores the data. Further, generating a track record of the user's online behavior may include generating a track record of the user's online behavior without using cookies.

In some embodiments, the method requires transmitting a hyperlink to a second device employed by the user to access the web hosting platform, such that when the hyperlink is activated, a second unique identifier is created for the user. Further, the method may include creating a second activity record for the user by linking the second activity record to the second unique identifier. Also, transmitting the hyperlink to a second device employed by the user may include transmitting the hyperlink by email or SMS. Additionally, the hyperlink may include a redirect link that, when activated, directs the user to a URL for the computer server.

In certain embodiments, the method includes displaying analytics related to the track record(s) of one or more users. Displaying analytics may include displaying analytics that include one of the webpages visited by one or more users, the time spent on each webpage, the number of internet sessions for one or more users, the duration of internet sessions for one or more users, the time of occurrence of internet sessions for one or more users, and the geographical location of one or more users.

In another aspect, embodiments of the invention provide a system for tracking the online behavior of internet users. The system includes a networked computer server configured with a web hosting platform, and an analytics database coupled to the computer server. The computer server is further configured to create a unique identifier for a user of the web hosting platform. The unique identifier is associated with a first device employed by the user to access the web hosting platform. The server is also configured to create a contact record configured to store identifying information of the user and linking the contact record to the unique identifier, and create an activity record for the user by linking the activity record to the unique identifier. The server is also configured to store the activity record, unique identifier, and contract record in the analytics database, and display the analytics to provide a track record of the online behavior for one or more users.

In a particular embodiment, the computer server is further configured to create a session event record for each session in which the user accesses the web hosting platform, wherein each session event record includes a unique session identifier, wherein each session event record is linked to the activity record. Further, the computer server may be further configured to create a page event record for each webpage the user visits during a session, wherein each page event record includes a unique page identifier.

In other embodiments, the computer server is further configured to create a page event record for each webpage the user visits during a session, wherein each page event record includes a unique page identifier, wherein each page event record is linked to the session event record for the session in which the page event record was created. The computer server may also be configured to create the unique identifier for the user comprises analyzing a plurality of features, of the first device employed by the user and of a web browser of the user, that are visible to the computer server, wherein the plurality of features are combined using a hash function to create a fixed-length string that serves as the unique identifier.

In a further embodiment, the computer server is configured to use a tracking program to track off-platform online behavior of the user when the user accesses websites without using the web-hosting platform, wherein the tracking program calculates the unique identifier of the user, and transmits data to a URL for the computer server, which encodes and stores the data. The tracking program is typically added to a webpage such that when the user visits the webpage without using the web-hosting platform, the tracking program transmits information, regarding the online behavior of the user, to the computer server.

In certain embodiments, the computer server is configured to transmit a hyperlink to a second device employed by the user to access the web hosting platform, such that when the hyperlink is activated, a second unique identifier is created for the user, and to create a second activity record for the user by linking the second activity record to the second unique identifier. Additionally, in some embodiments the hyperlink includes a redirect link that, when activated, directs the user to a URL for the computer server.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic diagram of a user-behavior tracking system showing the information flow between the tracking system and a system user, in accordance with an embodiment of the invention;

FIG. 2 is a flow diagram illustrating the process for tracking of online user behavior, according to an embodiment of the invention; and

FIG. 3 is a schematic illustration showing how various events are recorded by the user-behavior tracking system 100, in accordance with an embodiment of the invention; and

FIG. 4 is an exemplary display of analytics such as would be provided by the user-behavior tracking system, in accordance with an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Described herein is a system and method for improved tracking of user behavior across various web assets with or without cookies, across different sessions, web domains, internet-connected devices and internet browsers. In this context, assets can include web markup, downloadable media (including images and documents), scripts and stylesheets. More broadly, assets may be thought of as anything hosted on or accessed via the systems computer servers and related services.

Traditional cookie-based systems are limited to identification based on a single browser on a single device. Additionally, cookie-based identifiers are subsequent to client based obfuscation (clearing cookies, blocking cookies, etc.) There is no inherent way to link cookies across devices and browsers. As will be shown below, embodiments of the invention employ a system and method for tracking online user behavior without the use of cookies.

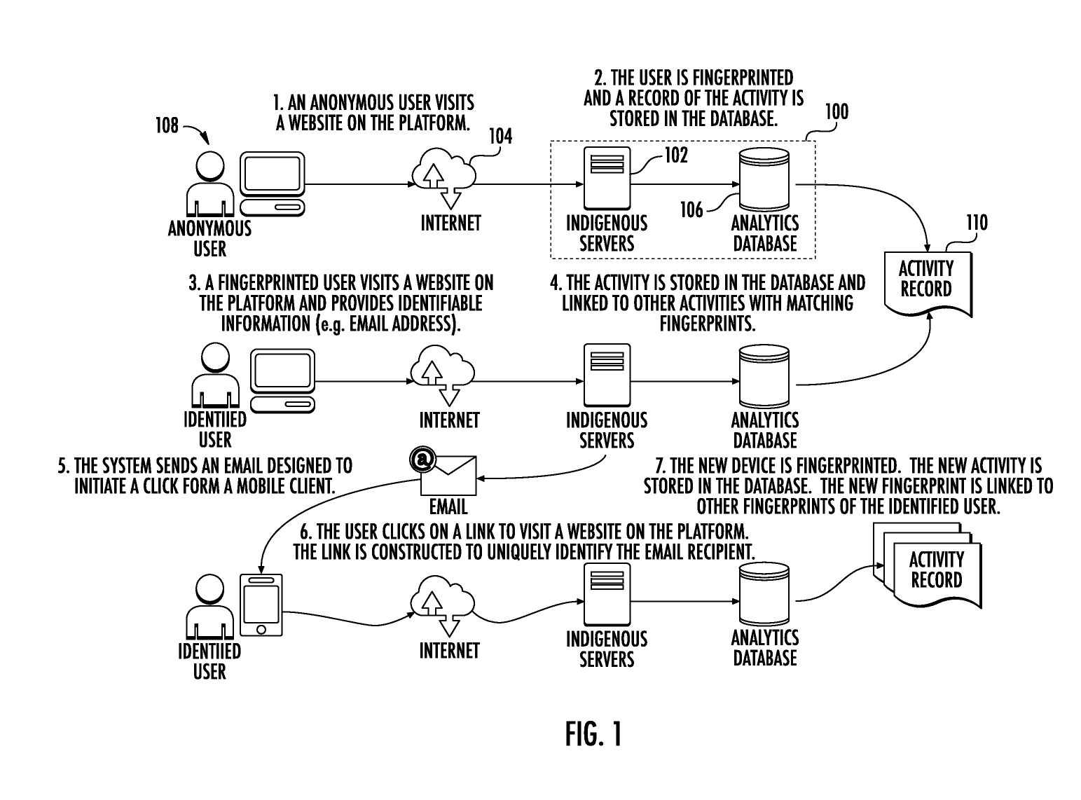

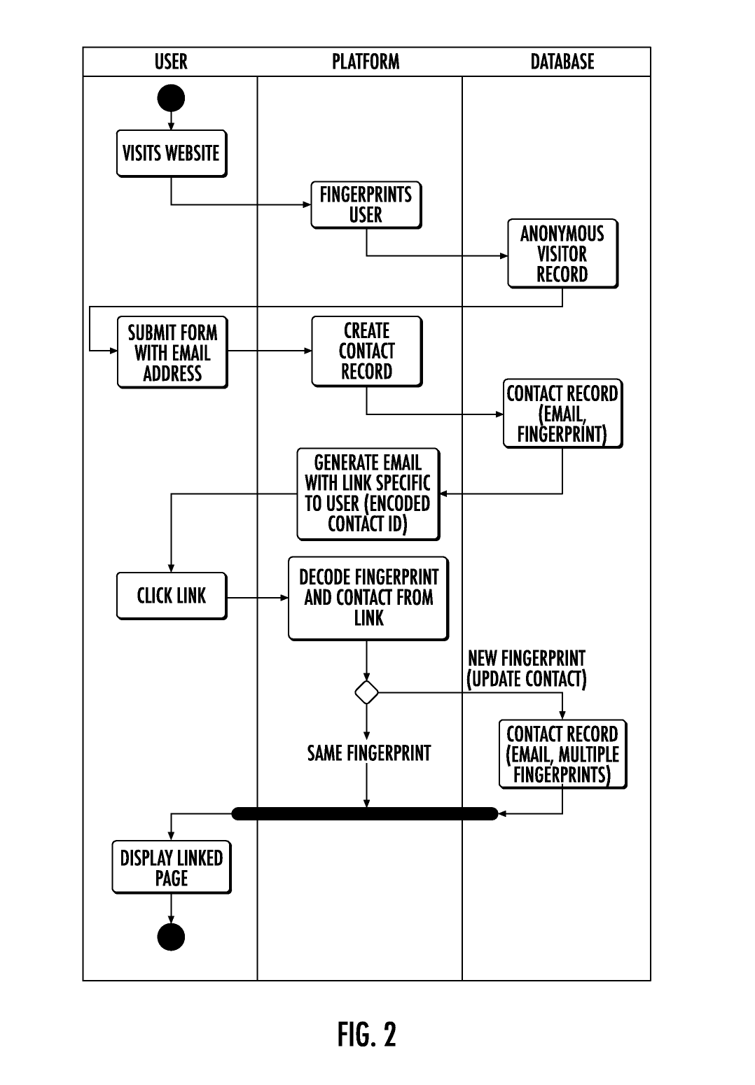

FIG. 1 is a schematic diagram of a user-behavior tracking system 100 showing the information flow between the tracking system 100 and a system user 108, in accordance with an embodiment of the invention. FIG. 2 is a flow diagram illustrating the process for tracking of online user behavior, according to an embodiment of the invention. FIGS. 1 and 2 provide examples of how the user-behavior tracking system 100 for a web hosting platform can be used to quantitatively describe the online actions of platform users without the use of cookies. The user-behavior tracking system 100 includes a system computer server 102 connected to a network, such as the internet 104. In a particular embodiment, the system server 102 is configured to fingerprint, or uniquely identify, every platform user 108 based on information in the request header (which includes user 108, browser, operating system, device and network features). This will occur before any assets are loaded and is not dependent on any assets (except when fingerprinting behavior offsite).

The system server 102 is also configured to associate that fingerprint, or unique identifier, with any online internet browsing sessions and with any detectable user behavior including, but not limited to, loading pages, clicking on links in those pages, and interacting with forms (on the web hosting platform). Furthermore, as will become clear, fingerprint-based identification of online users 108 is persistent across cache/cookie clears, and therefore does not suffer from the aforementioned shortcomings of traditional cookie-based systems.

As used herein, the term “fingerprint” describes a method for assigning to a unique identifier in the form of a variable, numerical equivalency, or pattern representative of the characteristics of a user 108, the user's browser, device, network, operating system, or other traits presented to the system server 102 while the user 108 is interacting with assets hosted on the system server 102. Depending on the features used to create the unique identifier, it is possible, though not required, that use of multiple browsers by a single user will generate multiple fingerprints (for each browser) that are all linked to the user. This may be true even if the browsers are accessed from the same device.

In a particular embodiment of the invention, the fingerprinting process (i.e., assigning the unique identifier to an anonymous user 108) takes place on the user's computer or mobile electronic device. It looks at a plurality of features of the web browser and user device that are visible to the system server 102. The plurality of features may be collected using an open source library. These features are then combined create the unique identifier, or fingerprint, that is thereafter associated with that particular user 108. In a particular embodiment, they are combined using a hash function to create a fixed-length string that uniquely identifies the user 108 based on the data collected by the system server 102. As will be explained below, embodiments of the present invention are configured to apply this fingerprinting process to a single user 108 across multiple different devices (e.g., desktop, laptop, tablet, smartphone, etc.) for accessing the internet 104 and across multiple internet browsers (Chrome, Safari, Firefox, Explorer, etc.).

Shown below is a list of exemplary features or data points that may be collected from each user 108, in the manner described above, in order to create the aforementioned unique identifier or fingerprint.

“user_agent”, (Browser identifier, i.e., what browser and browser version is being used)

“language”, (device language)

“screen_color_depth”,

“device_memory”,

“hardware_concurrency”, (e.g., number of cores, whether hyper threading is enabled)

“resolution”, (screen resolution)

“available resolution”, (maximum resolution available)

“timezone_offset”, (offset from UTC/GMT)

“session_storage”, (is session storage allowed)

“local_storage”, (is local storage allowed)

“cpu_class”, (CPU reported name)

“navigator_platform”, (e.g., operating system)

“regular_plugins”, (installed plugins)

“canvas”, (available features in the canvas of the web browser)

“adblock”, (if an ad blocker is in use)

“has_lied_languages”, (indicates if the browser reported different language from the system)

“has_lied_resolution”, (indicates if the browser reported different screen resolution from the system)

“has_lied_os”, (indicates if the browser reported different operating system from the system)

“has_lied_browser”, (indicates if the browser user_agent is not the actual user_agent)

“touch_support”, (indicates if the device supports touch input, e.g., smartphone)

“js_fonts”, (list of fonts available)

“audio_fp”, (characteristics of the users' audio support)

The foregoing features are captured and stored by the system server 102. In certain embodiments of the invention, the features are combined into a fixed-length string (i.e., the aforementioned hash value) which becomes the unique identifier, or fingerprint, for the corresponding user 108. Some of the values, for the features shown above, are determined by capturing and analyzing one or more different signals or values that may or may not be stored by the system server 102. Additionally, some of the values may be aggregations of other signals that are not stored on the system server 102 (for example, the *lied* values may depend on a number of different signals that are evaluated and used to calculate and return a Boolean value).

In the following example, we show how online behavior could be tracked by the user-behavior tracking system 100. In this example, the user 108 logs onto a networked device, such as a desktop, laptop, or tablet computer, and via the internet 104, accesses one or more websites through the aforementioned web hosting platform.

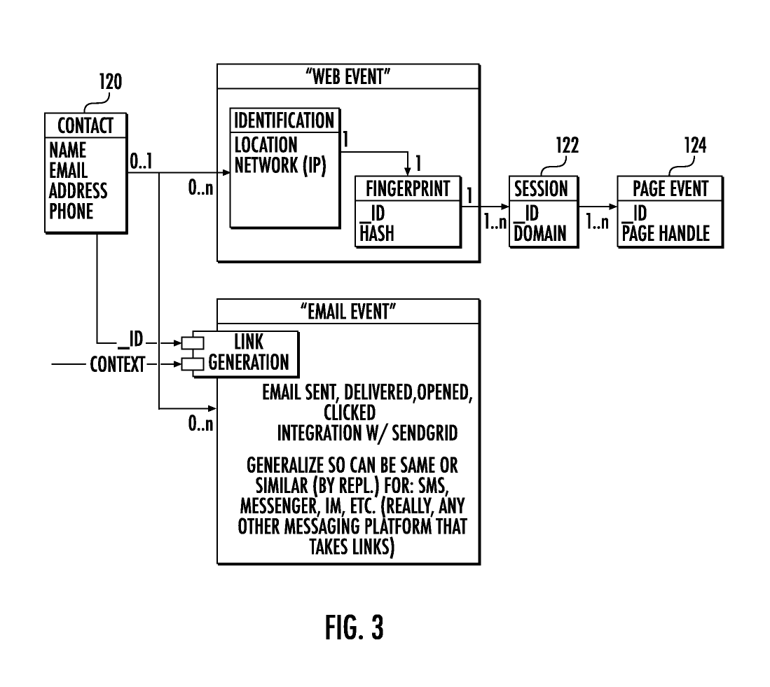

FIG. 3 is a schematic illustration showing how various events are recorded by the user-behavior tracking system 100, in accordance with an embodiment of the invention. When the user 108 is “fingerprinted” by the user-behavior tracking system 100, the system 100 automatically creates an identity record 120 for that user 108 which is stored in the analytics database 106. The identity record 120 of a known user 108 may be referred to as a “contact”. If the user-behavior tracking system 100 has no information on the user 108, the user 108 is tracked in the identity record 120 as an “Anonymous Visitor”.

Known users 108, or contacts, will be linked with fingerprint(s), session and user behaviors, including session events and page events. In this context, a “contact” is a known user 108. For example, the contact may be a user 108 that has volunteered information about their identity or provided contact information which allows for the platform operator to reach out to them. The user-behavior tracking system 100 includes a contact database of all known contacts, which may be included in the analytics database 106.

An activity record 110 (see FIG. 2) is created in which the user's 108 behavior is recorded. The tracked activities in the activity record 110 may include, but are not limited to, the webpages visited, the length of time on each webpage, the number and duration of internet sessions, timing of internet sessions, geographical location of users 108, etc. The activity record 110 is updated after each new online session by the user 108 to include the activities of the new session.

In particular embodiments, each online session by the user 108 results in the creation of a session event record 122 is assigned a session identifier or session id. Thus, an activity record 110 for a particular fingerprint may have multiple session event record 122 each with its own session id to track the behavior of the user 108 over time. Furthermore, each webpage visited by the user 108 results in a page event record 124 which includes its own page event identifier or page event id. Thus, any one session event record 122 may be associated with multiple page event records 124 showing how many webpages the user 108 visited during that particular session. If the user 108 accesses one or more websites through the aforementioned web hosting platform from a different device, another activity record 110 with a new fingerprint is created by the system server 102, and associated with the same user 108.

As stated above, the user-behavior tracking system 100 tracks the behavior of a user 108 as an “Anonymous Visitor” until the system 100 obtains some sort of identifying information regarding the user 108. This can happen, for example, if the user 108 electronically submits a form with their email, makes a purchase, or in some other way provides personal identifying information to the system server 102.

Typically, additional information may be added to the existing identity record at any time following its creation. For example, a link may be sent via the system server 102 using SMS or email to the user 108 from within the user-behavior tracking system 100. The destination of this link is “instrumented” by placing a special “redirect” link in front of it that has the identity of the user/recipient encoded in the uniform resource locator (URL) of the user-behavior tracking system 100. In a particular embodiment, this encoding is accomplished by appending a query parameter, containing the encoded user's identity, to the URL in a way that does not affect the link's behavior or the redirect.

In particular embodiments, the system server 102 is configured to automatically instrument all platform-sourced email marketing with unique hyperlinks (i.e., uniform resource indicators (URI)) and addresses on embedded media so that other devices and browsers, used by the same contact, can be fingerprinted and behaviors there-in collated with activity previously recorded in other browsers and devices.

Thus, when the user 108 clicks on the link in the SMS or email, the user 108 is redirected to the intended destination link. When that happens, the user-behavior tracking system 100 records the click. Additionally, the user-behavior tracking system 100 compares the fingerprint of the user 108 who clicks the link with the known fingerprint of the link's recipient. If the fingerprints are different, the user-behavior tracking system 100 adds the new fingerprint to the user's existing identity record. This allows the user-behavior tracking system 100 to accumulate multiple fingerprints for a single user 108 which are presumed to result from the use of different internet-access devices or different browsers.

In a particular embodiment, the identity record for a given user 108 maintains all of the unique identifiers, or fingerprints, that have created for the user 108. When the user's identity record contains multiple fingerprints, only one identity is associated with the various fingerprints.

In addition to tracking online behavior of users 108 using the platform on which the user-behavior tracking system 100 operates, particular embodiments of the user-behavior tracking system 100 support the “off-platform” tracking and collection of user behavior via a user tracking system “listener” program. More specifically, in cases where a website is hosted off-platform, the website may include a script for the listener that will collect the same information as collected on the system 100, provided that third party scripts are not blocked on the website.

The user-behavior tracking system listener is a tracking program, for example a javascript library, that can be included on any webpage. One way in which such a javascript library could be added to a webpage is via the following command: “<script src=//platformwebpage.com/js/scripts/collector-full.js></script>”, which provides a standard means to include an external javascript library on a webpage.

The library will make HTTP GET requests that will look like the following exemplary request:
https://platformwebpage.com/api/2.0/analytics/collect?sid=ABCD1234&ev=s&pt=1234567890 &uabn=chrome&uabv=5.0&f=c88ede79dab89ecf62cb802b43c8a392.

The query parameters in this URL provide fields that can be stored in the analytics database 106 of the user-behavior tracking system 100 as analytics. The following is an exemplary list of the types of analytics that might be stored.

sid: Session ID

ev: Event type

pt: Permanent Tracker (a cookie based tracker that we use)

uabn: User Agent Browser Name

uabv: User Agent Browser Version

f: fingerprint

fe: Full Entrance or the current URL that the user is on.

In a typical embodiment, these HTTP GET requests will fire approximately every 20 seconds or immediately whenever the user 108 navigates to a new page. Depending on the particular application, it is possible to arrange for the HTTP GET requests of fire at intervals shorter than, or longer than, 20 seconds. As the user 108 navigates between these off-platform webpages, the session ID will remain the same but the “fe” parameter will change. This allows the user-behavior tracking system 100 to see what webpages the user 108 is visiting and in what order.

In an exemplary embodiment, when a user 108 visits a webpage that has the user-behavior tracking program, or listener, the tracking program first calculates the unique identifier, or fingerprint, of the user 108 and sends a message to a URL of the user-behavior tracking system 100 (i.e., a URL for the system server 102) that encodes the data from the tracking program being stored by the system server 102 in the analytics database 106. The tracking program will then periodically send additional messages to the user-behavior tracking platform URL that will allow the user-behavior tracking system 100 to determine what webpages the user 108 visits and for how long.

In certain embodiments, the tracking program reports back to the system server 102 with information similar to what would be collected on the user-behavior tracking system 100. This collected information could include the account that the data belongs to, the webpage(s) viewed and for how long, and the fingerprint, or unique identifier, of the user 108.

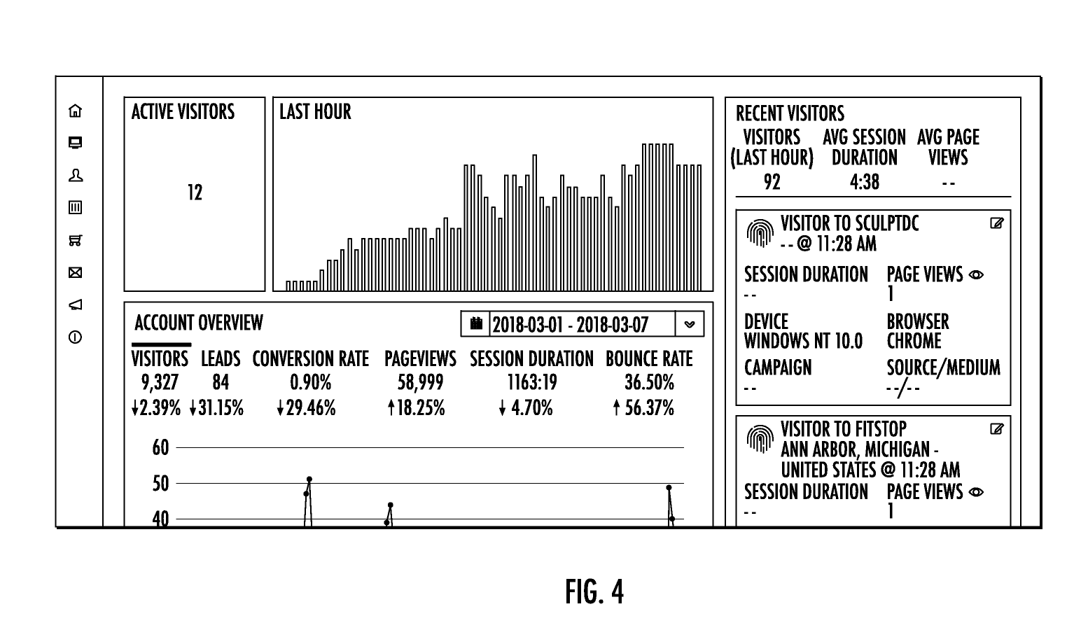

FIG. 4 is an exemplary display of analytics such as would be provided by the user-behavior tracking system, in accordance with an embodiment of the invention. The information gathered and collated by the user-behavior tracking system 100, and the resulting analytics calculated by the system server 102 is made possible by the association of one or more unique identifiers with a single user 108 so that the system server 102 can track online behavior over multiple devices and browsers without the use of client-side cookies. The unique identifier, or fingerprint, along with any session metadata, and page-event metadata is stored in the analytics database 106 coupled to the user-behavior tracking system server 102.

The system server 102 is further configured to provide a variety of analytics from tracking the behavior of users 108 of the user-behavior tracking system 100, where measurements and other quantitative features to describe the behavior of users 108 is captured and collated based on the use of fingerprint, session and user details gathered via the system server 102.

The collated data provides a more comprehensive picture of user behavior, which can also be used to segment users 108 (with or without a contact or known user identity), or for targeted email marketing, offline marketing, and/or custom content or offers presented synchronously in web assets. This facilitates customer segmentation, and personalization of marketing efforts to known and unknown users 108.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of tracking online user behavior, the method comprising the steps of:
providing a networked computer server which includes a web hosting platform, the computer server configured to provide a user access to the web hosting platform;
creating a unique identifier for the user of the web hosting platform, wherein the unique identifier is associated with a first device employed by the user to access the web hosting platform;
creating a contact record configured to store identifying information of the user and linking the contact record to the unique identifier;
creating an activity record for the user by linking the activity record to the unique identifier;
storing the activity record, unique identifier, and contract record in a database to generate a track record of the user's online behavior for display by the computer server.

2. The method of claim 1, further comprising creating a session event record for each session in which the user accesses the web hosting platform, wherein each session event record includes a unique session identifier.

3. The method of claim 2, wherein each session event record is linked to the activity record.

4. The method of claim 1, further comprising creating a page event record for each webpage the user visits during a session, wherein each page event record includes a unique page identifier.

5. The method of claim 4, wherein each page event record is linked to the session event record for the session in which the page event record was created.

6. The method of claim 1, wherein the analytics include one of the webpages visited, length of time spent on each webpage, the number of internet sessions, the time of occurrence of the internet sessions, and the geographical location(s) of the one or more users.

7. The method of claim 1, wherein creating the unique identifier for the user comprises analyzing a plurality of features, of the first device employed by the user and of a web browser of the user, that are visible to the computer server.

8. The method of claim 7, wherein the plurality of features are combined using a hash function to create a fixed-length string that serves as the unique identifier.

9. The method of claim 7, wherein the plurality of features includes one of a browser identifier, a device language, a screen color depth, screen resolution, maximum available screen resolution, hardware concurrency, device memory information, whether touch input is supported, and time zone information.

10. The method of claim 7, wherein the plurality of features includes one of CPU information, operating system information, installed plugins, the amount of local storage allowed, the amount of session storage allowed, whether an ad blocker being used, available features in the web browser, audio support characteristics, and available fonts.

11. The method of claim 7, wherein the plurality of features includes one or more indicators in which the information reported by the web browser is different from the information provided by the first device employed by the user.

12. The method of claim 1, further comprising using a tracking program to track off-platform online behavior of the user when the user accesses websites without using the web-hosting platform.

13. The method of claim 12, wherein using the tracking program to track off-platform online behavior of the user comprises using a javascript library to track off-platform online behavior of the user.

14. The method of claim 12, wherein the tracking program is added to a webpage such that when the user visits the webpage without using the web-hosting platform, the tracking program transmits information, regarding the online behavior of the user, to the computer server.

15. The method of claim 12, wherein the tracking program calculates the unique identifier of the user, and transmits data to a URL for the computer server, which encodes and stores the data.

16. The method of claim 1, wherein generating a track record of the user's online behavior comprises generating a track record of the user's online behavior without using cookies.

17. The method of claim 1, further comprising transmitting a hyperlink to a second device employed by the user to access the web hosting platform, such that when the hyperlink is activated, a second unique identifier is created for the user.

18. The method of claim 17, further comprising creating a second activity record for the user by linking the second activity record to the second unique identifier.

19. The method of claim 17, wherein transmitting the hyperlink to a second device employed by the user comprises transmitting the hyperlink by email or SMS.

20. The method of claim 17, wherein the hyperlink includes a redirect link that, when activated, directs the user to a URL for the computer server.

21. The method of claim 1, further comprising displaying analytics related to the track record(s) of one or more users.

22. The method of claim 21, wherein displaying analytics comprises displaying analytics that include one of the webpages visited by one or more users, the time spent on each webpage, the number of internet sessions for one or more users, the duration of internet sessions for one or more users, the time of occurrence of internet sessions for one or more users, and the geographical location of one or more users.

23. A system for tracking the online behavior of internet users, the system comprising:
a networked computer server configured with a web hosting platform; and
an analytics database coupled to the computer server;
wherein the computer server is further configured to:
create a unique identifier for a user of the web hosting platform, wherein the unique identifier is associated with a first device employed by the user to access the web hosting platform;
create a contact record configured to store identifying information of the user and linking the contact record to the unique identifier;
create an activity record for the user by linking the activity record to the unique identifier;
store the activity record, unique identifier, and contract record in the analytics database; and
display the analytics to provide a track record of the online behavior for one or more users.

24. The system of claim 23, wherein the computer server is further configured to create a session event record for each session in which the user accesses the web hosting platform, wherein each session event record includes a unique session identifier, wherein each session event record is linked to the activity record.

25. The system of claim 23, wherein the computer server is further configured to create a page event record for each webpage the user visits during a session, wherein each page event record includes a unique page identifier.

26. The system of claim 23, wherein the computer server is further configured to create a page event record for each webpage the user visits during a session, wherein each page event record includes a unique page identifier, wherein each page event record is linked to the session event record for the session in which the page event record was created.

27. The system of claim 23, wherein the computer server is further configured to create the unique identifier for the user comprises analyzing a plurality of features, of the first device employed by the user and of a web browser of the user, that are visible to the computer server, wherein the plurality of features are combined using a hash function to create a fixed-length string that serves as the unique identifier.

28. The system of claim 23, wherein the computer server is further configured to use a tracking program to track off-platform online behavior of the user when the user accesses websites without using the web-hosting platform, wherein the tracking program calculates the unique identifier of the user, and transmits data to a URL for the computer server, which encodes and stores the data.

29. The system of claim 28, wherein the tracking program is added to a webpage such that when the user visits the webpage without using the web-hosting platform, the tracking program transmits information, regarding the online behavior of the user, to the computer server.

30. The system of claim 23, wherein the computer server is further configured to transmit a hyperlink to a second device employed by the user to access the web hosting platform, such that when the hyperlink is activated, a second unique identifier is created for the user, and to create a second activity record for the user by linking the second activity record to the second unique identifier.

31. The method of claim 30, wherein the hyperlink includes a redirect link that, when activated, directs the user to a URL for the computer server.
